(19) United States
(12) Patent Application Publication
(10) Pub. No.: US 2008/0003854 A1
(43) Pub. Date: Jan. 3, 2008

(54) SYSTEMS AND METHODS FOR HOUSING ELECTRICAL COMPONENTS

(76) Inventor: Michael Pyle, Draper, UT (US)

Correspondence Address: BAKER & ASSOCIATES PLLC, 470 EAST NINTH AVENUE, SALT LAKE CITY, UT, 84103, US

(21) Appl. No.: 11/770,050

(22) Filed: Jun. 28, 2007

Related U.S. Application Data
(60) Provisional application No. 60/806,239, filed on Jun. 29, 2006.

(51) Int. Cl. H01R 29/00

(52) U.S. Cl. 439/188

(57) ABSTRACT

One embodiment relates to an encased electrical component board housing system, including an electrical component board encased within a housing. The housing includes an internal chassis, a base, and an intercoupled plurality of panels. The internal chassis supports the electrical component board within an internal region. The panels are selectively intercoupled so as to enclose the internal chassis. The panels are sequentially intercoupled to substantially audibly seal the intercoupling regions between the plurality of panels. The couplings between the panels include translation channels and coupling members extending into the internal chassis. The electrical component board includes audio and/or video functionality. A second embodiment relates to a method for substantially encasing an electrical component board within a housing. The method includes coupling two side panels to the internal chassis, rotatably coupling the front panel to the internal chassis, translating a top panel between two side panels, and translating a rear panel between two side panel.

### RELATED APPLICATIONS

This application claims priority to U.S. provisional application Ser. No. 60/806,239 filed Jun. 29, 2006, the contents of which are incorporated by reference.

### FIELD OF THE INVENTION

The invention generally relates to systems and methods for housing electrical components. In particular, the invention relates to systems and methods for encasing, protecting, and shielding audio and video related electrical components.

### BACKGROUND OF THE INVENTION

Audio and video components are designed to convert electrical signals into either audio or video outputs for conveying information to a user for purposes of entertainment or communication. For example, a television converts an electrical input signal into a visual image and a corresponding audible output. Improvements in technology have increased the performance of these devices so as to produce higher quality outputs. The quality of an audio or video output may be defined by the clarity or amount of undesirable signal present in the output. For example, a high quality audio output will include a minimal amount of audible noise such as static, crosstalk, etc. Likewise, a high quality video image will include a minimal amount of visual noise such as stray images, color patterns, distortion, etc.

Home entertainment has evolved from separate audio and video components to integrated multi-component systems that are used to maximize performance. For example, audio systems are designed to produce a relatively high level of audio output for purposes of listening to music or other types of audio information. Whereas, video components typically include the ability to produce both audio and video outputs. However, the audio systems included with most video components generally produce a lower quality output than a corresponding dedicated audio component. Therefore, components have been developed to couple with one another so as to increase performance or provide additional functionality. Various components are commonly electrically coupled together including video output devices, audio output devices, video input devices, audio input devices, networking devices, etc.

Modem presentations utilize audio and visual information to assist in communicate concepts in an effective and efficient manner. For example, presenters often utilize Powerpoint™ presentations to visually communicate concepts during a presentation. Presentations may also include media clips or audio recordings. As with home entertainment, higher quality audio and video is preferable to effectively convey concepts or entertain an audience during presentations.

The performance, reliability, and/or quality level of audio and video components is affected by a multitude of variables and characteristics. Advances in electrical technology alone do not necessarily solve certain performance problems with respect to audio and video components. For example, the quality of video produced by a video output component will be significantly affected by a power supply that includes an abundance of electrical abnormalities regardless of the video technology included in the particular video output device. It is also necessary for components to operate and intercouple with one another in a simplified, seamless and reliable manner so as to be utilized to the full potential. Therefore, there is a need in the industry for systems and methods of increasing audio and video performance by incorporating technologies that maximize performance characteristics. In addition, there is a need in the industry for systems and methods that allow users to more effectively utilize audio and video components, including integration, interfaces, and operational systems.

### SUMMARY OF THE INVENTION

Embodiments of the present invention relate to systems and methods for mechanical housing of electrical components. One embodiment relates to an encased electrical component board housing system, including an electrical component board encased within a housing. The housing includes an internal chassis, a base, and an intercoupled plurality of panels. The internal chassis supports the electrical component board within an internal region. The base supports the housing over a supporting surface. The panels are selectively intercoupled so as to enclose the internal chassis. The panels are sequentially intercoupled to substantially audibly seal the intercoupling regions between the plurality of panels. The couplings between the panels include translation channels and coupling members extending into the internal chassis. The electrical component board includes audio and/or video functionality. A second embodiment relates to a method for substantially encasing an electrical component board within a housing. The method includes coupling two side panels to the internal chassis, rotatably coupling the front panel to the internal chassis, translating a top panel between two side panels, and translating a rear panel between two side panels.

Conventional electrical housings generally include numerous coupling devices extending from exterior to interior, such as screws and rivets. Unfortunately, these coupling systems often loosen and allow unsophisticated users to disassemble and expose sensitive electrical components housed within. In addition, the sequence of assembly and disassembly of conventional housings often requires the housings to be substantially box-like to properly allow each portion to interconnect with one another. Likewise, conventional housings are often inconvenient for accessing internally housed electrical components. Embodiments of the present invention overcome such limitations of the prior art.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the system according to the invention. In the Figures, the physical dimensions may be exaggerated for clarity. The figure numbers corresponded to the respective page number.

FIG. 1 illustrates an exploded perspective view of an integrated electrical component system including one embodiment of an encased electrical component board housing system;

FIGS. 2-4 illustrates a sequence of disassembling the encased electrical component board housing system illustrated in FIG. 1 in accordance with embodiments of the present invention; and

FIG. 5 illustrates a flow chart of a method for substantially encasing an electrical component board within a housing in accordance with a second embodiment of the present invention.

### DETAILED DESCRIPTION OF THE INVENTION

Embodiments of the present invention relate to systems and methods for mechanical housing of electrical components. One embodiment relates to an encased electrical component board housing system, including an electrical component board encased within a housing. The housing includes an internal chassis, a base, and an intercoupled plurality of panels. The internal chassis supports the electrical component board within an internal region. The base supports the housing over a supporting surface. The panels are selectively intercoupled so as to enclose the internal chassis. The panels are sequentially intercoupled to substantially audibly seal the intercoupling regions between the plurality of panels. The couplings between the panels include translation channels and coupling members extending into the internal chassis. The electrical component board includes audio and/or video functionality. A second embodiment relates to a method for substantially encasing an electrical component board within a housing. The method includes coupling two side panels to the internal chassis, rotatably coupling the front panel to the internal chassis, translating a top panel between two side panels, and translating a rear panel between two side panel. Also, while embodiments of the present invention are described in the context of housing systems for audio and video components, it is appreciated that the teachings of the present invention are applicable to other areas.

The following terms are defined for purposes of utilization throughout this application:

Internal Chassis—For purposes of this application, an internal chassis is a three dimensional mechanical support structure with corresponding three dimensionally oriented regions surrounding the structure including a front, rear, left side, right side, bottom, and top region. These regions do not necessarily correspond to the surface structure or shape of the internal chassis but are used for three dimensional reference purposes in describing the positioning of structures exterior to the internal chassis.

Sequentially intercoupled—a set of structures intercoupled in a manner that limits the sequence with which they may be assembled or disassembled. For example, the housing panels in certain illustrated embodiments are sequentially coupled in a manner that prevents removing certain panels without first removing others.

Regions of interconnection—regions between interconnected structure. For example, in the illustrated embodiments, the sides, tops, and bottoms of the panels.

Keyed coupling—a type of coupling between structures in which one of the structures includes specifically sized region to receive the other structure.

Translatable coupling—a type of coupling between structures in which one of the structures translates with respect to the other structure to engage the coupling.

Electrical component board—A board configured to house a plurality of electrical components, wherein the electrical components are mechanically coupled to the board and electrically coupled to one another. In addition, electrical component boards may mechanically and electrically couple with a bus or receiver unit to facilitate support. An electrical component board may include a mounting structure for normalizing the size of multiple standard printed circuit boards (PCB).

Vertical alignment—A device that is vertically aligned or positioned such that its longest dimension is oriented in a substantially vertical plane or normal to a supporting surface. For example, a telephone pole is aligned vertically.

Plenum—A module for redirecting air flow. In the illustrated embodiments, the plenum is disposed below the electrical component boards.

Audio input device—An electrical device configured to produce audio signals including but not limited to a receiver, tuner, digital media player (CD, DVD, etc.), television, computer, gaming console, portable media player, etc.

Audio output device—An electrical device configured to receive and broadcast audio signals in an audible format, including but not limited to speakers, subwoofers, tweeters, headphones, etc.

Video input device—An electrical device configured to produce video signals including but not limited to a cable receiver, tuner, television, computer, gaming console, etc.

Video output device—An electrical device configured to receive and broadcast video signals in a visual format, including but not limited to a monitor, television, cell phone, portable media player, etc.

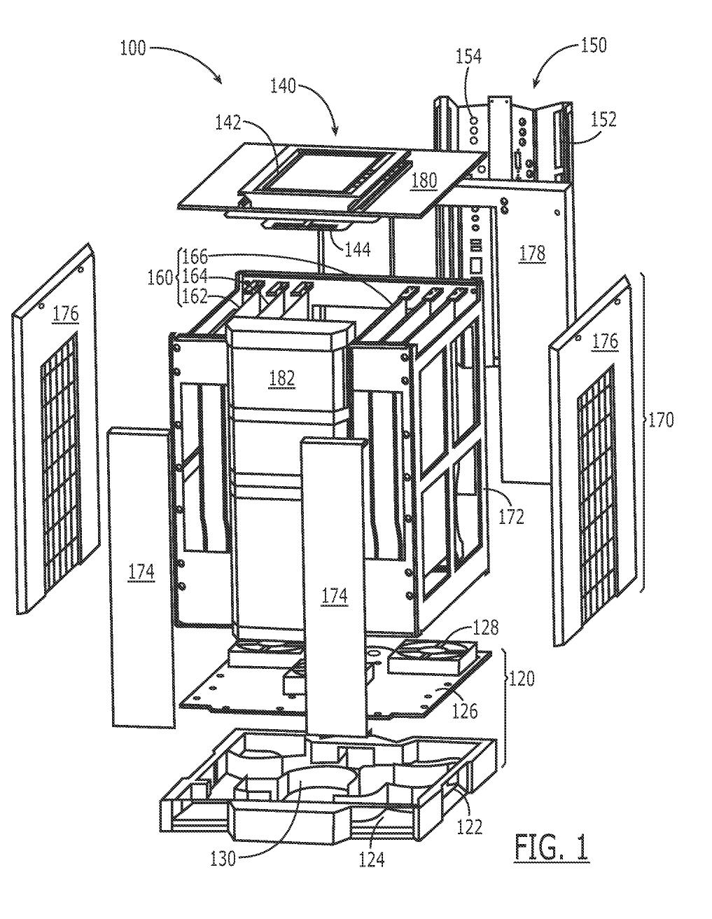

Reference is initially made to FIG. 1, which illustrates an exploded perspective view of an integrated electrical component system including one embodiment of an encased electrical component board housing system, designated generally at 100. The illustrated system also contains a particular cooling system, which will be described briefly below for reference purposes. The vertical nature of the illustrated system 100 affects the orientation of the associated interconnection panel 150. The system 100 includes a set of electrical component boards 160, a plenum 120, an outlet 140, and a housing 170. The illustrated electrical component boards 160 include six boards, three of which are designated respectively as a first, second, and fourth board 162, 164, 166. Various systems may hold as few as two electrical component boards and still incorporate the teachings of the present invention. The illustrated electrical component boards 160 include individual electrical components electrically intercoupled as a conventional printed circuit board to provide audio and/or video functionalities. Each of the electrical component boards 160 may be a conventional audio or video component without its housing, such as a DVD player, game console, DVR, etc. The electrical component boards 160 are also electrically intercoupled with one another to further provide audio and/or video functionalities. The electrical intercoupling of the individual electrical component boards 160 is configured to integrate their functionalities and includes both software and hardware integration. To facilitate the proper air flow, the electrical component boards 160 are oriented vertically with the longest axis oriented perpendicular to the supporting surface. The orientation of the boards 160 is mechanically supported by the housing 170 and more particularly by an internal chassis or racking system 172. The electrical component boards 160 may further include mounting structures so as to ensure consistent shaping among the individual boards. The internal chassis or racking system creates a particular spacing between the boards as illustrated.

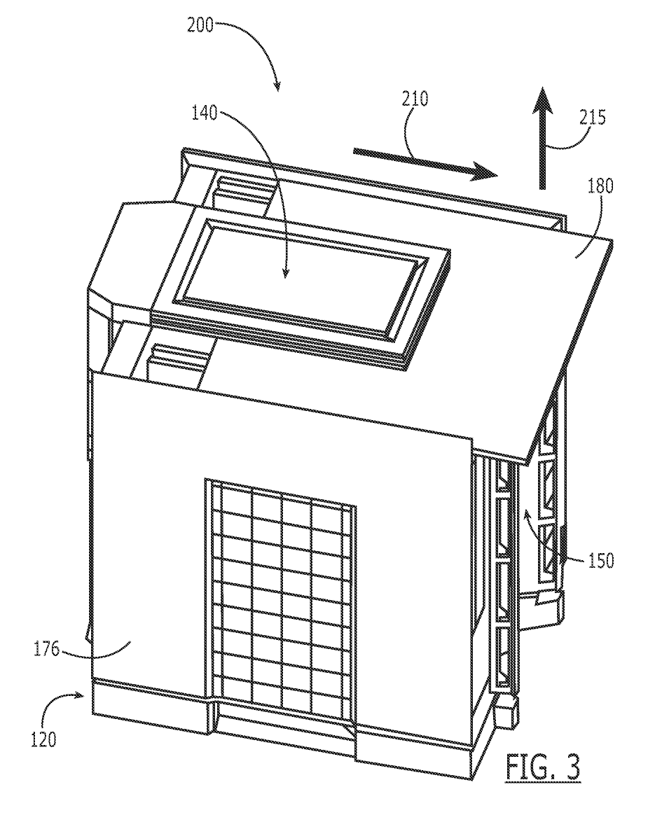

The plenum 120 is disposed below the housing 170 and the electrical component boards 160. The plenum 120 facilitates the intake and direction of ambient air for the cooling system 100. The plenum 120 includes a front inlet 124, a lateral inlet 122, a set of air guides 130, a cover 126, and a set of fans 128. The inlets 122, 124 receive ambient air from the surrounding environment and allow it to enter the system at a location vertically below the electrical component boards 160. This location of air intake is critical for the overall system's ability to utilize the natural process of convection for heat transfer. The set of air guides 130 and cover 126 create independent air flow channels that horizontally direct air flow to regions that are vertically aligned between the individual electrical component boards 160. In the illustrated embodiment, these vertically aligned locations correspond to the positioning of the fans 128. It should be noted that the fans 128 enhance the natural convectional air flow and are optional components. Therefore, even if the fans 128 are removed or begin to malfunction, the system 100 will circulate ambient air through convection alone. In the illustrated embodiment, the fans 128 enhance the air flow by further directing the air vertically from the plenum 120 between the electrical component boards 160. Additional details and description of the plenum 120 and its associated-system wide functionality and internal technology will be discussed in reference to FIGS. 3A-3B.

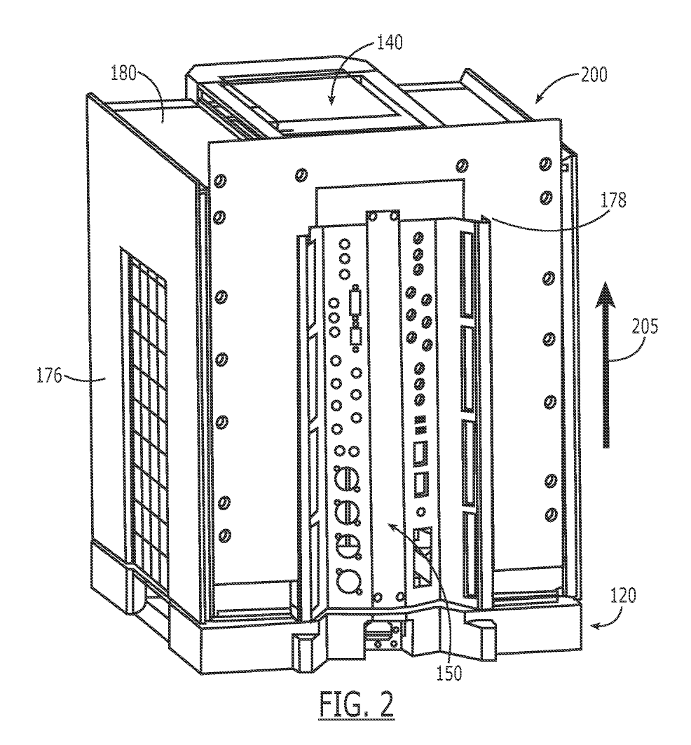

The housing 170 substantially encases and supports the electrical component boards 160 in the vertically oriented configuration illustrated and described above. The region within the housing 170 receives air flow vertically from the plenum 120, allowing it to flow vertically around and between the electrical component boards 160 and then exhaust toward the outlet 140. The air flow adjacent to the electrical component boards is naturally heat affected because of the difference in heat between the ambient air received from the plenum 120 and the heat generated by the operation of the electrical component boards 160. To normalize the heat between the two, the heat from the electrical component boards 160 is released, thereby heat affecting the air. This heat exchange process causes the air to rise in both temperature and position, thereby naturally causing the vertical air flow cycle of the system 100 through convection. The air flow cycle will be illustrated and described in more detail with reference to FIGS. 2A-2C.

The housing 170 includes a plurality of panels, a set of front panels 174, a set of side panels 176, a rear panel 178, and a top panel 180. The housing 170 further includes an internal chassis 172, a front console 182, and a rear connection panel 150. The panels 174, 176, 178, 180 mechanically couple to one another and the internal chassis 172 to define an internal region in which the electrical component boards 160 are housed. The encasement of electrical components is well used in the electronics industry for purposes such as dust protection, electrical isolation, and noise dampening. The front console 182 includes various electrical interconnections, human interface modules, and remote control transceiver locations. The interconnection panel 150 provides a plurality of electrical connections for input and output to the electrical component boards 160. The interconnection panel includes a retaining member 152 and a set of electrical couplers 154.

The outlet 140 is disposed on the top cover 180 of the housing 170 to facilitate the exhaust of the temperature affected air through convectional heat transfer principles. The outlet 140 is disposed above the electrical component boards 160 and at the apex of the system 100 to enable heated air to naturally rise away from the electrical component boards 160 and exhaust out of the system 100. The outlet 140 includes an internal baffle 144 and an external port 142. The temperature affected air from within the housing will flow both horizontally and vertically around the baffle 144 and out through the external port 144 so as to be recombined with the ambient air, thereby creating an air flow cycle.

Reference is next made to FIGS. 2-4, which illustrate a sequence of disassembling the encased electrical component board housing system illustrated in FIG. 1, wherein the sequence is designated generally at 200. The sequence 200 may also be performed in reverse order to illustrate a sequence of assembly. The panels 174, 176, 178, 180 are releasably coupled to the internal chassis 172 in a specific sequence that includes intercoupling the panels 174, 176, 178, 180 with each other. The intercouplings between the panels 174, 176, 178, 180 limits the sequence with which panels may be removed from and/or engaged with the system 100. In additional, the intercoupling of the panels substantially audibly seals the regions of interconnection between for improviding performance. Various audio, electrical, noise, cooling, aesthetic, and protection benefits are also accomplished by encasing the internal chassis 172 in this manner. In particular, FIG. 2 illustrates the rear panel 178 being translatably coupled within a rear translation channel of the side panels 176. The rear translation channel may be configured to create a substantially flush coupling between the side panels 176 and the rear panel 178. In addition, the rear translation channel is oriented to create a positional abudment coupling or engagement between the rear panel 178 and the top panel 180. Alternatively, the rear panel 178 may include an upper hook type engagement with the top panel 180. The rear panel 178 is substantially U shaped and is coupled around the connector panel 150, as illustrated. The rear panel 178 translates in a vertical orientation with respect to the side panels 176. The removal of rear panel 178 includes vertically translating the rear panel 178 upward as indicated by arrow 205. The rear panel 178 is also optionally coupled directly to the internal chassis 172 via a plurality of coupling members (not shown) that extend through the recesses illustrated on the rear panel 178 and couple into the internal chassis 172. The coupling members include but are not limited to screws, rivets, wedges, etc. The rear panel 178 is the only panel in the illustrated embodiment that includes an exposed coupling system. The advantages of hiding the remaining coupling systems includes security, aesthetics, and functionality.

In particular, FIG. 3 illustrates the top panel 180 translatably coupled within a top translation channel of the side panels 176. The top panel 180 horizontally translates between the open and closed configuration. The top translation channel is oriented to position the top panel 180 in positional abutment or engagement with the front panels 174. The top translation channel may also be configured to create a substantially flush coupling between the side panels 176 and the top panel 180. In addition, the top panel 180 may include some form of mechanical engagement with the front panels 174. The top panel 180 is substantially U shaped and is translatably coupled around the outlet 140, as illustrated. The removal of the top panel 180 from the system 100 includes a horizontal rear translation represented by arrow 210 and a vertical rotation and lift represented by arrow 215. The vertical rotation and lift is necessary route a portion the top panel 180 free of the side panels 176.

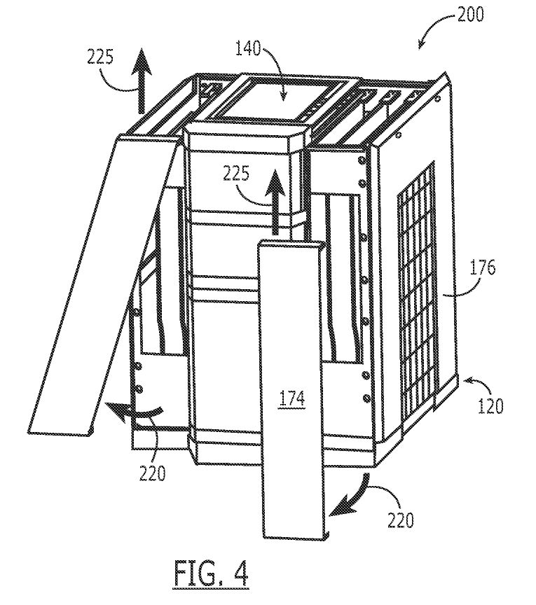

In particular, FIG. 4 illustrates the front panels 174 coupled to the internal chassis 172 directly via an upper hook coupling member. The upper hook coupling member allows the top of the front panels 174 to be rotatably coupled to a top region of the internal chassis. The remaining portion of the front panels 174 may then be rotated toward the internal chassis. A coupling member (not shown) extends through a hidden lower recess on the front panels and directly couples to the internal chassis 172. The top and bottom couplings of the front panels 174 create a positional abutment or engagement with the side panels 176. Alternatively, a releasable male/female clamping may be engaged between the front panels 174 and the respective side panels 176. It will also be noted that the described coupling may be utilized with a single front panel and/or additional front panels. The front panels 174 are positioned on either side of a front connection panel 182 in the illustrated system 100. The removal of the front panels 174 from the system 100 includes releasing/removing the hidden coupling member represented by arrow 220, and vertically raising and/or rotating represented by arrow 225, the front panel 174 from the internal chassis 172. FIG. 2 illustrates the left front panel 174 rotating and raising and the right front panel translating and raising. Either of these or other removal processes may be utilized in removing the front panels 174 from the system 100. Although not illustrated, the side panels 176 may then be removed from the internal chassis 172 to completely expose the internal chassis and provide access to the internal region. The side panels 176 are coupled directly to the internal chassis 172 via any well known hidden mechanical couplings including but not limited to an upper hook type coupling, a male/female engagement coupling, etc.

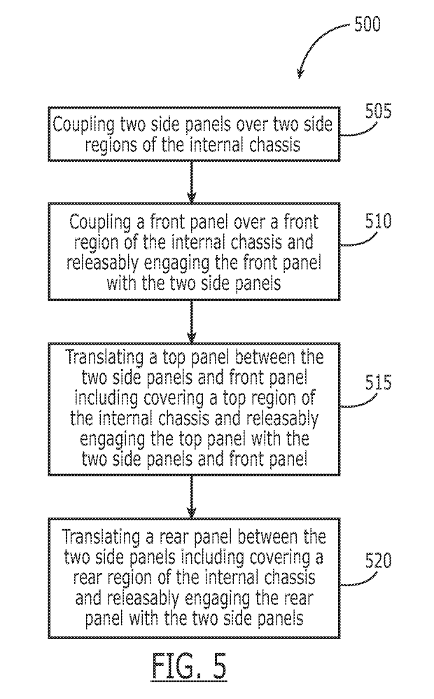

Reference is next made to FIG. 5, which illustrates a flow chart of a method for substantially encasing an electrical component board within a housing, designated generally at 500. It will be appreciated that the illustrated method may be reversed for purposes of decoupling an encased housing. The method includes coupling the two side panels over side regions of the internal chassis, act 505. The coupling of the side panels may include extending a plurality independent coupling members through the side panels into the internal chassis. Coupling a front panel over a front region of the internal chassis and releasably engaging the front panel with the two side panels, act 510. The coupling of the front panel may include rotatably coupling a portion of the front panel over a top portion of the internal chassis and extending a coupling member through the front panel into the internal chassis. Translating a top panel between the two side panels and front panel including covering a top region of the internal chassis and releasably engaging the top panel with the two side panels and front panel, act 515. The translation of the top panel may include horizontally translating the top panel within a top translation channel defined by the two side panels. Translating a rear panel between the two side panels including covering a rear region of the internal chassis and releasably engaging the rear panel with the two side panels. The translation of the rear panel may include vertically translating the rear panel within a rear translation channel defined by the two side panels.

Various other embodiments have been contemplated, including combinations in whole or in part of the embodiments described above.

What is claimed is:

1. An encased electrical component board housing system comprising:
an electrical component board;
a housing substantially encasing the electrical component board, wherein the housing comprises:
an internal chassis configured to mechanically support the electrical component board within an internal region, wherein the internal chassis includes a front region, a rear region, a top region, a bottom region, and two side regions enclosing the internal chassis;
a base coupled to the bottom region of the internal chassis and configured to mechanically support the housing above a supporting surface;
a plurality of panels releasably coupled to the internal chassis substantially enclosing the internal chassis in connection with the base, wherein the plurality of panels comprise:
two side panels directly coupled to the internal chassis over the two side regions of the internal chassis;
a front panel coupled over the front region of the internal chassis and releasably coupled to the two side panels;
a top panel translatably coupled to the two side panels and the front panel over the top region of the internal chassis; and
a rear panel translatably coupled to the two side panels over the rear region of the internal chassis.

2. The system of claim 1, wherein the plurality of panels are sequentially intercoupled with one another substantially audibly sealing the regions of interconnection between the plurality of panels and the base, wherein the sequential intercoupling includes a plurality of mechanical keyed couplings that requires a specific sequence of coupling and decoupling among the plurality of panels.

3. The system of claim 1, wherein the plurality of panels are shaped and configured to releasably engage with the base.

4. The system of claim 1, wherein the front panel includes a rotatable hook coupling member configured to hook over an upper portion of the internal chassis.

5. The system of claim 1, wherein the two side panels include a plurality of independent coupling members extending through the side panels and coupled to the internal chassis.

6. The system of claim 1, wherein two side panels include a top translation channel disposed in correspondence with the top region of the internal chassis, and wherein the top panel is translatably coupled to the two side panels within the top translation channel.

7. The system of claim 1, wherein two side panels include a rear translation channel disposed in correspondence with the rear region of the internal chassis, and wherein the rear panel is translatably coupled to the two side panels within the rear translation channel.

8. The system of claim 1, wherein the top panel is translatably coupled to the two side panels and front panel around an air flow vent disposed on the top region of the internal housing.

9. The system of claim 1, wherein the rear panel is translatably coupled to the two side panels around an electrical interconnection panel disposed on the rear region of the internal housing.

10. A method for substantially encasing an electrical component board within a housing comprising the acts of:
providing an electrical component board disposed within an internal chassis;
providing a base coupled to a bottom surface of the internal chassis substantially covering a bottom region of the internal chassis;
coupling two side panels over two side regions of the internal chassis;
coupling a front panel over a front region of the internal chassis including releasably engaging the front panel with the two side panels;
translating a top panel between the two side panels including covering a top region of the internal chassis and releasably engaging the top panel with the two side panels and the front panel; and
translating a rear panel between the two side panels including covering a rear region of the internal chassis and releasably engaging the rear panel with the two side panels and the top panel.

11. The method of claim 10, wherein the act of coupling two side panels over two side regions of the internal chassis includes extending a plurality of independent coupling members through the two side panels into the internal chassis.

12. The method of claim 10, wherein the act of coupling a front panel over a front region of the internal chassis includes rotatably coupling the front panel over a top portion of the internal chassis.

13. The method of claim 12, wherein the act of coupling a front panel over a front region of the internal chassis includes extending a coupling member through the front panel into the internal chassis.

14. The method of claim 10, wherein the act of translating a top panel between the two side panels includes horizontally translating the top panel within a top translation channel of the two side panels.

15. The method of claim 14, wherein the act of translating a top panel between the two side panels includes horizontally translating the top panel to releasably engage with the front panel.

16. The method of claim 10, wherein the act of translating a rear panel between the two side panels includes vertically translating the rear panel within a rear translation channel of the two side panels.

17. The method of claim 16, wherein the act of translating a rear panel between the two side panels includes vertically translating the rear panel to releasably engage with the top panel.

18. The method of claim 10, wherein the act of coupling a front panel over a front region of the internal chassis includes coupling two independent front panels over an exposed front region of the internal chassis.

19. The method of claim 18, wherein the act of coupling a front panel over a front region of the internal chassis includes coupling the two independent front panels around an electrical interface.

20. A method for substantially encasing an electrical component board within a housing comprising the acts of:
providing an electrical component board disposed within an internal chassis;
providing a base coupled to a bottom surface of the internal chassis substantially covering a bottom region of the internal chassis;
coupling two side panels over two side regions of the internal chassis including extending a plurality of independent coupling members through the two side panels into the internal chassis;
coupling a front panel over a front region of the internal chassis including releasably engaging the front panel with the two side panels including rotatably coupling the front panel over a top portion of the internal chassis;
translating a top panel between the two side panels including covering a top region of the internal chassis and releasably engaging the top panel with the two side panels and the front panel including horizontally translating the top panel within a top translation channel of the two side panels; and
translating a rear panel between the two side panels including covering a rear region of the internal chassis and releasably engaging the rear panel with the two side panels and the top panel includes vertically translating the rear panel within a rear translation channel of the two side panels.
